(19) United States
(12) Patent Application Publication
(10) Pub. No.: US 2004/0158991 A1
(43) Pub. Date: Aug. 19, 2004

(54) Safety for a folding knife

(75) Inventor: Jeff Freeman, Salem, OR (US)

Correspondence Address: Jeffrey S. Gundersen, Foley & Lardner, Suite 3800, 777 East Wisconsin Avenue, Milwaukee, WI, 53202-5306, US

(73) Assignee: Alterra Holdings Corporation

(21) Appl. No.: 10/366,647

(22) Filed: Feb. 13, 2003

(51) Int. Cl. B26B 3/06

(52) U.S. Cl. 30/161

(57) ABSTRACT

A folding knife includes a handle and a blade pivotally coupled to the handle. A safety has a locked position configured to lock the blade into a closed position. The safety has an o-ring configured to maintain the safety in the locked position such that the safety is protected against unintended movement out of the locked position.

### FIELD OF THE INVENTION

The present invention relates to a folding knife. In particular, the present invention relates to a folding knife having a safety that is used to prevent inadvertent rotation of the knife blade out of either an extended or a closed position.

### BACKGROUND OF THE INVENTION

Folding knives typically include a handle and one or more blades pivotally attached to the handle, the blades having a compact closed position and an extended open position. Folding knives may be manually operated, have an assisted-opening mechanism, or have an automatic opening mechanism for moving the blade from the closed into the extended position.

In folding knives having a manual operation, a user opens the blade by grasping the blade or pushing a knob protruding from the blade in order to rotate the blade into the extended position. Assisted opening knives include a bias mechanism that aids the user in opening the blade, typically requiring the user to open the blade a certain amount manually, then assisting the opening of the blade for the rest of the blade travel. Automatic knives include a bias mechanism configured to fully open the blade upon actuation of an opening mechanism, such as a push button.

A folding knife may have a locking mechanism configured to lock the blade into one or both of the closed and extended positions. A number of such locking mechanisms are known, including liner locks having a spring arm that engages the rear of the blade to lock the blade open and other sliding or push button mechanisms that engage the blade to prevent blade rotation.

In more sophisticated folding knives, a safety may be included to maintain the blade into the closed position. Such a safety may be particularly desirable in the case of automatic knives to ensure that the blade is not inadvertently opened.

There are several features that may be desirable in the design of a safety for a folding knife. For example, it would be desirable to have a safety that has a “positive feel” when moved between locked and unlocked positions. Further, it would be desirable to have a safety that locks the blade in both the closed position and the extended position. Further still, it may be desirable to provide a safety that directly interacts with the blade rather than preventing motion of the mechanism used to operate the blade. Finally, it would be desirable to provide a safety that positively maintains its desired position to prevent accidental disengagement of the safety.

Folding knives are typically provided with a blade stop that stops travel of the blade in the opening direction at some desired point. The positioning of the blade stop is important to insure that the blade opens enough to permit engagement of a locking mechanism, such as a liner lock, if provided, and also to reduce any play in the extended position when such a lock is engaged. Because the interaction between the blade stop and a locking device requires exact positioning of the elements, folding knife components may need to be manufactured to exacting specifications, thus increasing the cost of the knife.

It would be desirable to provide a blade stop for a folding knife that is adjustable in order to permit higher dimensional tolerances in the manufacture of the knife components while still meeting standards with respect to ensuring engagement of the knife lock and reducing play in the fully extended position.

One way of permitting increased tolerances in the manufacture of folding knife components is to utilize an eccentric adjustment mechanism, such as that described in U.S. Pat. application Ser. No. 09/731,106, filed Dec. 6, 2000, titled “Folding Knife Liner Lock Adjustment Method and Apparatus,” which is incorporated herein by reference in its entirety.

It would be desirable to provide a folding knife that provides one or more of the above mentioned or other advantageous features. Other features and advantages will be made apparent from the present specification. The teachings disclosed extend to those embodiments that fall within the scope of the appended claims, regardless of whether they accomplish one or more of the aforementioned needs.

### SUMMARY OF THE INVENTION

The invention relates to a folding knife having a handle and a blade pivotally coupled to the handle. A safety has a locked position configured to maintain the blade in a closed position. The safety has an o-ring configured to maintain the safety in the locked position, whereby the safety is protected against unintended movement out of the locked position.

The invention further relates to a folding knife having a handle and a blade pivotally coupled to the handle. A blade stop is coupled to the handle and the blade stop engages the blade to stop rotation of the blade in an opening direction. The blade stop has a first segment with a first central longitudinal axis and a second segment having a second central longitudinal axis, the first central longitudinal axis being non-collinear with the second longitudinal axis.

The invention further relates to a safety for a folding knife. The safety includes a substantially cylindrical pin and a pair of o-ring grooves cut into the pin proximate one another and separated by a barrier. A first shoulder ring is raised above a surface of the pin and an o-ring is configured to snugly fit into each of the o-ring grooves.

Further still, the invention relates to a folding knife having a handle and a blade pivotally coupled to the handle. A safety has a locked position configured to lock the blade into a closed position. The safety includes means for maintaining the safety in the locked position such that the safety is protected against unintended movement out of the locked position.

The invention is capable of other embodiments and of being practiced or carried out in various ways. Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a side view of a folding knife having the blade and certain internal mechanisms shown in phantom lines;

FIG. 2 is an exploded perspective view of a folding knife;

FIG. 3 is a perspective view of a safety for a folding knife;

FIG. 4 is a sectional view of a folding knife taken generally along line 4-4 of FIG. 2;

FIG. 5 is the view of FIG. 4 with the blade in the closed position;

FIG. 6 is a sectional view of a safety for a folding knife taken generally along line 6-6 of FIG. 5; and

FIG. 7 is a perspective view of a blade stop for a folding knife.

### DESCRIPTION OF PREFERRED AND OTHER EXEMPLARY EMBODIMENTS

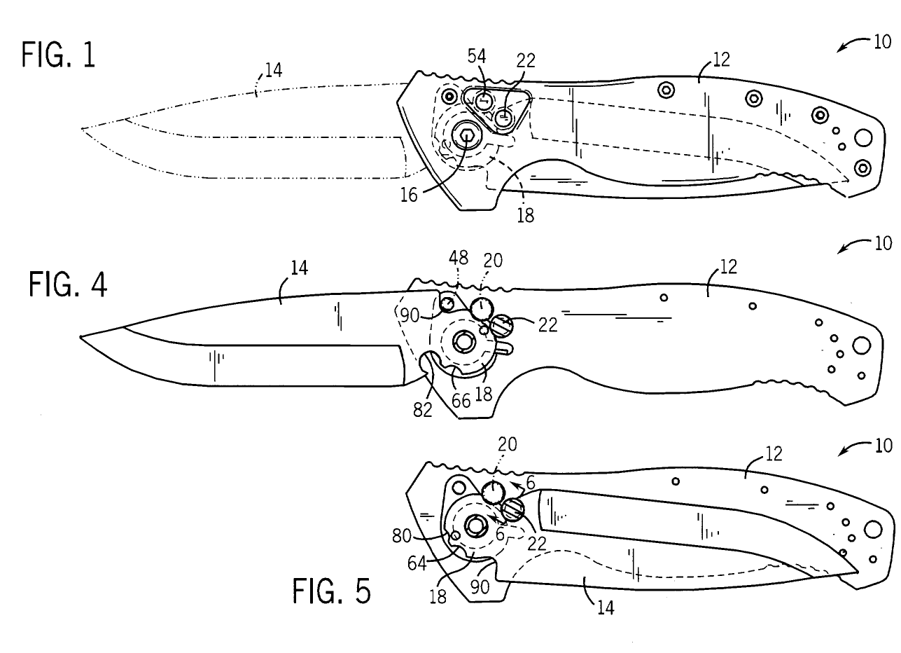

Referring to FIG. 1, a knife, shown as folding knife 10, has a handle 12 and a blade 14 pivotally coupled to the handle 12. The blade 14 has an open, extended position and a closed, compact position. The blade 14 is pivotally coupled to the handle 12 by an axle 16 extending through a tang 18 of the blade 14.

Further referring to FIG. 1, in an exemplary embodiment, the folding knife 10 is an automatic knife such that the blade 14 may be automatically opened by depressing a push button 54. A safety 22 prevents unintended actuation of the automatic opening mechanism.

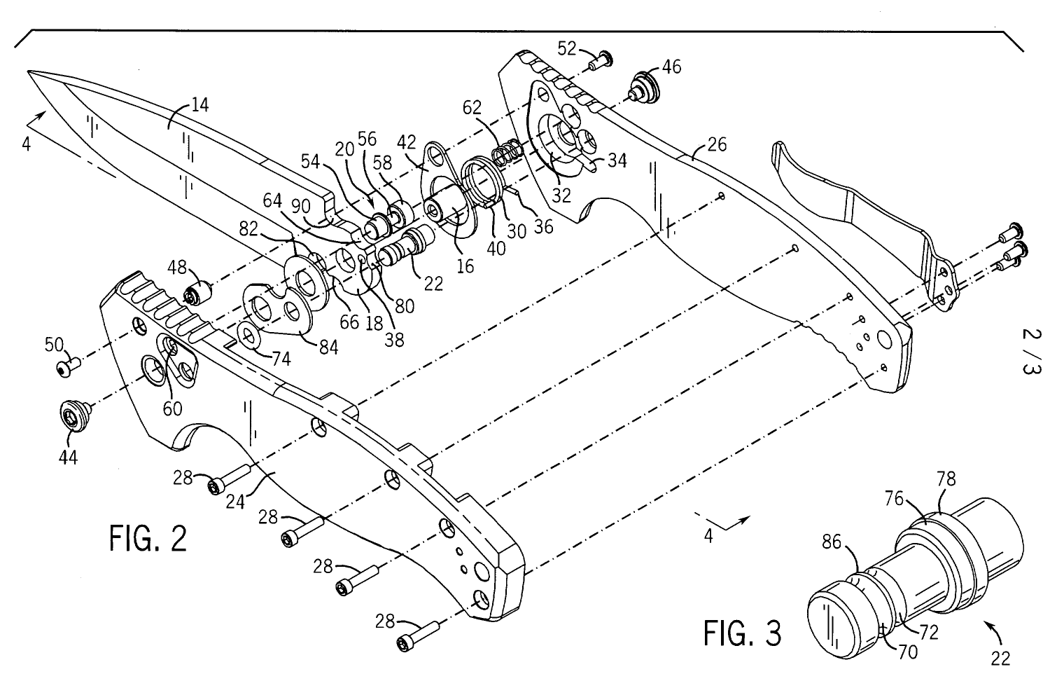

Referring to FIG. 2, the folding knife 10 of an exemplary embodiment has a pair of handle sides 24, 26 that are attached to one another by a number of handle screws 28. A bias mechanism, shown as torsion spring 30, is coupled between the blade 14 and handle side 26 to provide a bias on the blade 14 in the opening direction. The torsion spring 30 is received within a recess 32 within handle side 26. The recess 32 may include an extension 34 that receives an arm 36 of torsion spring 30. Further, the tang 18 may include an aperture 38 to receive a second arm 40 of the torsion spring 30. A washer 42 maintains the torsion spring 30 within the recess 32 in handle side 26.

Further referring to FIG. 2, axle 16 is secured between handle sides 24, 26 by axle fasteners 44, 46. A blade stop 48 is secured between handle sides 24, 26 by blade stop screws 50, 52.

An actuator 20 controls the operation of the automatic opening mechanism of folding knife 10. Actuator 20 includes the push button 54, a narrow central portion 56, and an end portion 58. The push button 54 extends into an actuator aperture 60 in handle side 24 and is biased out of handle side 24 by an actuator spring 62.

The actuator 20 is maintained in a locked position under the bias of actuator spring 62. When in the locked position, the end portion 58 directly interferes with rotational movement of blade 14 via engagement with-the tang 18. When the blade 14 is extended, end portion 58 rests within contoured portion 64. When the blade 14 is in the closed position, end portion 58 rests within contoured portion 66. To open the blade 14, a user may depress push button 54, thus disengaging end portion 58 from the tang 1 8 and permitting the torsion spring 30 to rotate blade 14 into the extended position. Note how the tang 18 may rotate past the central portion 56 without interference as opposed to the end portion 58. The constructions and components associated with the automatic opening mechanism depicted in FIG. 2 are exemplary only. Many spring biased mechanisms are known for automatically operating a folding knife and may be used within the scope of the present invention.

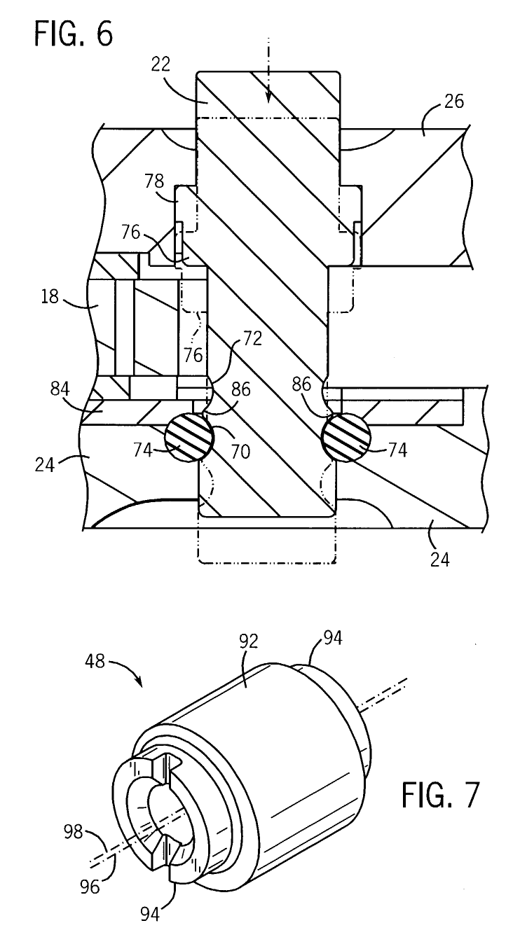

Referring to FIGS. 2-6, and FIG. 3 in particular, in an exemplary embodiment, safety 22 is a metal pin. Safety 22 has a pair of o-ring grooves 70, 72 configured to seat an o-ring 74 (see FIG. 2), which is used to maintain the safety 22 in a locked position. A raised portion, shown as a pair of shoulder rings 76, 78, has a greater diameter than the rest of safety 22. When shoulder ring 76 is disposed in the same plane as tang 18, the shoulder ring 76 prevents rotation of the tang 18. The tang 18 may include two notches, shown as contoured portions 80, 82, that receive shoulder ring 76, thus locking the blade 14. Shoulder ring 78 is sized to not fit into contoured portions 80, 82, such that when a user locks the safety 22, the safety 22 slides the appropriate amount and not further past tang 18 (see FIG. 6).

The two ends of safety 22 extend through apertures in handle sides 24, 26. In order to engage and disengage safety 22, a user depresses the end portion extending out of one of the handle sides 24, 26 in order to change the position of the safety 22. When safety 22 is engaged with the tang 1 8 (meaning the shoulder ring 76 is in the same plane as tang 18 and received within one of contoured portions 80, 82), the blade 14 may not be rotated until the safety 22 is disengaged. This configuration provides a redundant locking capability to the actuator 20 in both the extended and closed positions of the blade 14. Accordingly, even if push button 54 of actuator 20 is inadvertently depressed, a locked safety 22 will prevent motion of blade 14. In another embodiment, safety 22 prevents motion of the blade 14 out of the closed position only. In still another embodiment, the safety 22 interferes with movement of the actuator 20 to maintain the position of the blade rather than directly interfering with the blade tang 18.

Referring to FIG. 6, safety 22 is shown in solid lines in a disengaged configuration and in dotted lines in an engaged position. In the exemplary embodiment depicted in FIG. 6, o-ring 74 is seated within o-ring groove 70 when safety is disengaged and is seated within o-ring groove 72 when safety 22 is locked. The o-ring 74 is prevented from moving in a transverse direction because it is fixed between handle side 24 (such as in a counter bore) and stop washer 84 (see also FIG. 2). 0-ring 74 is made of an elastic material such as rubber and has a bias to remain seated within o-ring grooves 70, 72.

To change the position of safety 22, the user must overcome the bias of o-ring 74 to shift the o-ring 74 into the adjacent o-ring groove. This configuration aids in maintaining the safety 22 in a particular position as the safety 22 is unlikely to slide in a transverse direction without positive input from the user. Further, the user receives a tactile and possibly audible sensation when changing the position of safety 22 because once o-ring 74 is stretched to rise over ridge of barrier 86 between o-ring grooves 70, 72, the o-ring 74 will snap into engagement with the adjacent o-ring groove, snapping the safety 22 into proper position.

Referring to FIGS. 2 and 7, blade stop 48 is configured to prevent further rotation of blade 14 in the opening direction such that the blade 14 stops at the proper location for engagement by actuator 20 and possibly safety 22. Actuator 20 must be depressed in order to rotate the blade 14 out of the extended position and safety 22 must be in the disengaged configuration to do so in an exemplary embodiment. Blade stop 48 prevents further rotation of blade 14 via direct interference with tang 18 in notch 90. If the blade stop 48 permits over-rotation of blade 14 in the opening direction, one of actuator 20 or safety 22 may not properly slide into contoured portions 64 and 80, thus preventing proper locking of the blade 14. Likewise, if blade stop 48 does not permit full rotation of blade 14, the same circumstance may apply. Accordingly, the blade stop 48 must be properly positioned relative to blade 1 4 such that all components interact properly.

One way of ensuring that the blade stop 48 interacts properly with blade 14 is to produce the associated components with exacting dimensional tolerances. Another way of addressing the problem is to provide a shape of contours 64, 80 that permits engagement with actuator 20 and safety 22 over a larger angle of rotation of blade 14. A difficulty with this approach is that changing the shape of contours 64, 80 may result in play of the blade 14 in the extended position, even when locked open, because a more forgiving contour 64, 80 may also shift relative to actuator 20 or safety 22 when one or both of the devices are engaged with the blade 14.

In one embodiment of the present invention, the blade stop may be given a non-circular cross-section such that rotation of the blade stop will thereby adjust the position at which the blade engages the blade stop. Referring to FIG. 7, in another embodiment, the blade stop may have an eccentric configuration wherein a segment, shown as center portion 92, has a circular cross-section but has a central longitudinal axis 96 that is not collinear with the central longitudinal axis 98 of one or more adjacent segments, such as end portions 94. Accordingly, when the blade stop 48 is rotated about the central longitudinal axis of the end portions 94, the position at which the center portion 92 engages blade 14 changes due to the eccentric rotation of center portion 92, thus adjusting the final extended position of the blade 14. Because the final position of blade 14 in the extended direction may be adjusted, the various components of folding knife 10 may be manufactured with higher dimensional tolerances, possibly decreasing the cost of manufacturing folding knife 10.

In order to adjust the contact point between the blade stop 48 and notch 90 during manufacture of folding knife 10, the blade stop 48 is rotated, such as by inserting a tool, such as a screwdriver, through one of the handle sides 24, 26 to engage and rotate blade stop 48 until the blade and blade stop 48 contact position has been properly adjusted. The blade stop screws 50, 52 may then be screwed into corresponding apertures in blade stop 48, locking the blade stop 48 into its final adjusted position.

In an alternative embodiment, the blade stop may be attached directly to the blade, such as in the form of thumb studs extending from the blade. The blade stop would then interact with the handle to stop rotation of the blade. Such a blade stop may have an eccentric (or other non-circular) design such as a described above to permit adjustment of the extended position of the blade.

While the detailed drawings and specific examples given herein describe various exemplary embodiments, they serve the purpose of illustration only. It is to be understood that the invention is not limited in its application to the details of construction and the arrangements of components set forth in the preceding description or illustrated in the drawings. For example, although an actuator is shown locking the blade into the extended position, the safety may be used in conjunction with other types of blade locks, such as liner locks. Further, although the blade stop is shown as having an eccentric segment used for adjusting the extended position of the blade, the blade stop may be other shapes that change the contact point between the blade stop and the blade when the blade stop is rotated or otherwise adjusted. Furthermore, other substitutions, modifications, changes, and omissions may be made in the design, operating conditions, and arrangements of the exemplary embodiments without departing from the scope of the invention as expressed in the appended claims.

What is claimed is:

1. A folding knife, comprising:
a handle;
a blade pivotally coupled to the handle, the blade having a closed position and an extended position; and
a safety having a locked position configured to lock the blade into the closed position, the safety having an o-ring configured to maintain the safety in the locked position, whereby the safety is protected against unintended movement out of the locked position.

2. The folding knife of claim 1, further comprising a shoulder ring extending from the safety, wherein the shoulder ring engages the blade when the safety is in the locked position to prevent rotation of the blade thereby locking the blade into the closed position.

3. The folding knife of claim 1, wherein the o-ring maintains the safety in the locked position by seating in a groove in the safety.

4. The folding knife of claim 1, wherein the o-ring maintains the safety in an unlocked position when the safety is in the unlocked position.

5. The folding knife of claim 4, wherein the handle comprises a pair of handle sides, each having an aperture receiving an end of the safety, wherein the position of the safety may be changed from the locked position to the unlocked position via user engagement of one of the ends of the safety.

6. The folding knife of claim 5, wherein the o-ring encircles the safety and is fixed with respect to the handle, wherein the o-ring changes location on the safety when the safety is moved.

7. The folding knife of claim 1, wherein the safety is further configured to lock the blade into the extended position.

8. The folding knife of claim 1, further comprising a bias mechanism providing a bias on the blade into the extended position and an actuator for automatically opening the knife by permitting the bias mechanism to rotate the blade into the extended position.

9. The folding knife of claim 8, wherein the actuator locks the blade in the extended position.

10. A safety for a folding knife, comprising:
a substantially cylindrical pin;
a pair of o-ring grooves cut into the pin proximate one another and separated by a barrier;
a first shoulder ring raised above a surface of the pin; and
an o-ring configured to snugly fit into each of the o-ring grooves.

11. The safety for a folding knife of claim 10, further comprising a second shoulder ring raised above the surface of the pin adjacent the first shoulder ring, the second shoulder ring having a diameter greater than a diameter of the first shoulder ring.

12. A folding knife, comprising:
a handle;
a blade pivotally coupled to the handle; and
a safety having a locked position configured to prevent inadvertent opening of the blade, the safety having means for maintaining the safety in the locked position, whereby the safety is protected against unintended movement out of the locked position.

13. The folding knife of claim 12, wherein the means for maintaining the safety in the locked position is an o-ring encircling the safety and fixed in position in a recess in a side of the handle.

14. The folding knife of claim 12, further comprising a bias mechanism providing a bias on the blade into an extended position and an actuator for automatically opening the knife by permitting the bias mechanism to rotate the blade into the extended position.

15. The folding knife of claim 14, wherein the actuator locks the blade in the extended position.

16. The folding knife of claim 12, further comprising a shoulder extending from the safety, wherein the shoulder engages the blade when the safety is in the locked position to prevent rotation of the blade.

17. The folding knife of claim 16, wherein the blade comprises a tang having a contoured surface that coacts with the shoulder to lock the blade into the closed position.

18. The folding knife of claim 12, wherein the handle comprises a pair of handle sides, each having an aperture receiving an end of the safety, wherein the position of the safety may be changed from the locked position to an unlocked position via user engagement of one of the ends of the safety.

19. The folding knife of claim 12, further comprising a first groove and a second groove in the safety.

20. The folding knife of claim 19, wherein the means for maintaining the safety in a locked position interacts with the first groove in the safety.

21. The folding knife of claim 20, wherein the means for maintaining the safety in a locked position is an o-ring that maintains the safety in an unlocked position by seating in the second groove in the safety.

22. The folding knife of claim 12, wherein the safety maintains the blade in an extended position when the safety is in the locked position and the blade is in the extended position.

23. A folding knife, comprising:
a handle;
a blade pivotally coupled to the handle; and
a blade stop coupled to the handle, wherein the blade stop engages the blade to stop rotation of the blade in an extended position, the blade stop having a first segment with a first central longitudinal axis and a second segment with a second central longitudinal axis, the first central longitudinal axis being non-collinear with the second longitudinal axis.

24. The folding knife of claim 23, wherein the extended position is adjusted during manufacture of the knife via rotation of the blade stop.

25. The folding knife of claim 24, further comprising a bias mechanism providing a bias on the blade into the extended position and an actuator for automatically opening the knife by permitting the bias mechanism to rotate the blade into the extended position.

26. The folding knife of claim 25, wherein the actuator locks the blade in the extended position via engagement with a first notch in the blade.

27. The folding knife of claim 26, further comprising a safety that coacts with the blade to maintain the blade in the extended position via engagement with a second notch in the blade.

28. The folding knife of claim 23, wherein the handle comprises a pair of handle sides, each having an aperture receiving a blade stop screw, wherein the blade stop screws fix the blade stop to the handle sides.

29. The folding knife of claim 23, wherein each of the segments has a circular cross section.
